(19) United States
(12) Patent Application Publication
(10) Pub. No.: US 2006/0087411 A1
(43) Pub. Date: Apr. 27, 2006

(54) Wireless remote monitoring apparatus for car security

(76) Inventor: Myung Hyun Chang, Cheongju (KR)

Correspondence Address: PARK LAW FIRM, 3255 WILSHIRE BLVD, SUITE 1110, LOS ANGELES, CA, 90010, US

(21) Appl. No.: 11/080,107

(22) Filed: Mar. 15, 2005

(30) Foreign Application Priority Data
Oct. 26, 2004 (KR) 10-2004-0085581

(51) Int. Cl. B60R 25/10

(52) U.S. Cl. 340/426.18

(57) ABSTRACT

A wireless remote monitoring apparatus for car security notifies a proper remote person or place of situation that a car is robbed or damaged or it needs repairs. The apparatus includes a monitoring unit for monitoring an abnormal state of a car, such as forcible opening of a door of the car or an external shock applied to the car; a photographing unit for photographing the inside or outside of the car when the monitoring unit detects the abnormal state of the car; a memory for storing an image photographed by the photographing unit; a GPS unit attached to the car for obtaining location information of the car; a clock for checking the time when the image and location information are obtained; and a communication unit for radio-transmitting the image, the location information and the time information to a remote server.

### CROSS-REFERENCE TO RELATED APPLICATION

This application claims benefit under 35 U.S.C. § 119 from Korean Patent Application No. 10-2004-0085581, filed on Oct. 26, 2004, the entire content of which is incorporated herein by reference.

### BACKGROUND OF THE INVENTION

1. Field of the Invention

The present invention relates to a wireless remote monitoring apparatus for car security. More specifically, the invention relates to a wireless remote monitoring apparatus for car security, which wirelessly notifies a proper remote person or place of a situation where a car is robbed or damaged or it needs repairs to effectively cope with the situation.

2. Background of the Related Art

Generally, conventional car security apparatuses put on the market are switched between a monitoring state and an alarm clearing state by a remote controller. Most of them merely sound the alarm when the door of a car is forcibly opened or external shock is applied to the car.

A wireless reporting apparatus using mobile communication system that is disclosed in Korea Patent Application No. 10-1999-11583, which was invented and applied by the similar applicant so that of the present invention. This invention informed mobile communication subscriber to detection signal, robbery of car, robbery of material having a warehouse, a fire of warehouse and interruption of electric power, recharging of battery using a vehicle and a ship. Etc. But this invention not supplied to information of accident at real-time.

A wireless car security system that is closed in U.S. Pat. No. 5,648,754. Which is a car security apparatus and a car security system for protecting a vehicle from car theft and tampering which notifies a user of the details regarding an abnormal condition that takes place during the activation of a security function of the apparatus. When any sensor detects and abnormal condition with the security function in an armed mode, a controller stores in a memory device the identification of the sensor that detects the abnormal condition and the time of detection as security information. In response to a predetermined operation performed the user, the controller reads the security information from the memory device and transmits the security information to another on board device (audio or audio/visual device) having a display. The device receives and then presents the security message using alphanumeric characters on the display.

Car robbery can be a public hazard because a robbed car can be maliciously used for a crime. Particularly, when an expensive car is robbed or damaged, its owner or insurance company can suffer huge financial damage. Thus, it is preferable to find out the person who robs or damages the car and retrieve the robbed car. However, the aforementioned conventional car security apparatuses merely sound the alarm when a car is robbed or damaged, but do not take follow-up measures.

In the meantime, when a car needs repairs, the driver usually manages it in person such that he/she calls a repair shop or the like. Thus, a driver suffers from an inconvenience when the driver is not the owner of the car or the driver does not know the telephone number of the repair shop. There is therefore a need for a system capable of rapidly and simply connecting with a person or place that can help the driver in case of emergency situation.

### SUMMARY OF THE INVENTION

Accordingly, the present invention is directed to a wireless remote monitoring apparatus for car security that substantially obviate one or more problems due to limitations and disadvantages of the related art.

An object of the present invention is to provide a wireless remote monitoring apparatus for car security, which wirelessly transmits image information of the outside or inside of a car and location information of the car to a remote server when an abnormal state of the car is detected and notifies an appropriate callback center or the owner of the car of the abnormal state such that the callback center or the car owner can take follow-up measures.

To accomplish the above object, according to the present invention, there is provided a wireless remote monitoring apparatus for car security, which includes a monitoring unit for monitoring an abnormal state of a car, such as forcible opening of a door of the car or an external shock applied to the car; a photographing unite attached to the car for photographing the inside or outside of the car when the monitoring unit detects the abnormal state of the car; a memory for storing an image photographed by the photographing unit; a GPS unit attached to the car for obtaining location information of the car; a clock for checking the time when the image and location information are obtained; and a communication unit for radio-transmitting the image stored in the memory, the location information obtained by the GPS and the time information obtained by the clock to a remote server.

The memory stores the location information obtained by the GPS and the time information obtained by the clock. The communication unit radio-transmits the location information and time information stored in the memory.

The remote server can transmit the image, location information and time information stored in the memory to a callback center through wired or wireless communication. Preferably, the remote server transmits customer information, such as the telephone number, address and name of a customer and a person in charge in the callback center, to the callback sensor through wired or wireless communication. The callback center can be a car repair shop, an insurance company, a police station and a security service company.

The remote server can transmit the image, location information and time information to a wireless communication terminal of the owner of the car through wireless communication.

Preferably, the communication unit is operated when the monitoring unit detects an abnormal state of the car. The wireless remote monitoring apparatus further comprises a hot key for operating the communication unit. The hot key operates the communication unit without regard to whether the monitoring unit is turned on or off to radio-transmit the location information obtained by the GPS and the time information obtained by the clock to the remote server. In this case, the remote server transmit the location information and time information, which are transmitted from the communication unit by the operation of the hot key, to the callback through wired or wireless communication.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram of a wireless remote monitoring apparatus for car security according to a preferred embodiment of the present invention.

### DETAILED DESCRIPTION OF THE PREFERRED EMBODIMENT

Reference will now be made in detail to the preferred embodiments of the present invention, examples of which are illustrated in the accompanying drawings.

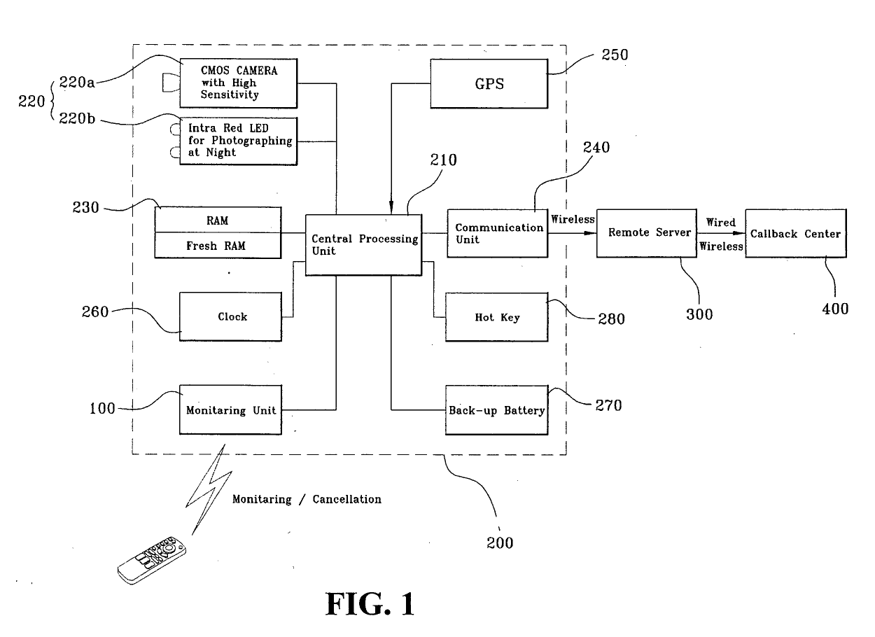

FIG. 1 is a block diagram of a wireless remote monitoring apparatus 200 for car security according to a preferred embodiment of the present invention. Referring to FIG. 1, the wireless remote monitoring apparatus 200 is not operated when a monitoring unit 100 is turned off but it is operated when the monitoring unit 100 is turned on to be in an alarm monitoring state. This cooperative operation of the apparatus 200 and the monitoring unit 100 is controlled by a central processing unit 210.

When the monitoring unit 100 is turned on, it becomes the alarm monitoring state. When the monitoring unit 100 detects that the door of a car is forcibly opened or external shock is applied to the car in the alarm monitoring state, the monitoring unit 100 sounds the alarm and, simultaneously, notifies the central processing unit 210 of the abnormal state of the car. The monitoring unit 100 can be a smart unit that sounds a voice, alarm or warning sound in response to a degree of emergency.

The wireless remote monitoring apparatus 200 for car security is operated only when the monitoring unit 100 detects an abnormal state of the car. Specifically, a photographing unit 220 attached to the car photographs the outside or inside of the car under the control of the central processing unit 210. It is preferable that the photographing unit 220 includes a CMOS camera 220a with high sensitivity and an infrared LED 220b for photographing at night because the car can be robbed not only in the daytime but also in the night. The images photographed by the photographing unit 220 are stored in a memory 230 such as a RAM or flash RAM.

The wireless remote monitoring apparatus 200 for car security includes a GPS 250 and a clock 260. The GPS 250 is attached to the car to detect location information of the car. The clock 260 is used for checking the time of obtaining the location information and image information.

The wireless remote monitoring apparatus 200 is connected to a battery mounted in the car through a cigar jack or an appropriate connecting line and operated using the battery as a power source. The wireless remote monitoring apparatus 200 can further include a rechargeable secondary battery as a back-up battery 270.

When the monitoring unit 100 notifies the central processing unit 210 that the car is in an abnormal state, the central processing unit 210 controls the image stored in the memory 230, the location information detected by the GPS 250 and time information obtained by the clock 260 to be wirelessly transmitted to a remote server 300 through a communication unit 240.

In consideration of capacity of the memory 230, photographing of the photographing unit 220 can be carried out from the moment an abnormal state is generated in the car for a limited period of time. Otherwise, the photographing unit 220 can performs its photographing operation for unlimited period of time such that new images are stored in the memory 230, replacing previously stored images, when the memory 230 is full. In this case, the image firstly stored in the memory 220 is replaced with a new image first. Furthermore, it is preferable to radio-transmit an image to be replaced with a new image to the remote server 300 through the communication unit 240 in advance before the image is replaced with the new image. Photographing can be carried out continuously or intermittently at an interval of several seconds or minutes.

It is preferable that the location information obtained by the GPS 250 is radio-transmitted to the remote server 300 in real time. However, when location information matched with image photographing time is needed, it is possible to store an image, time and location information corresponding to the image in the memory 230 and then radio-transmit them.

The remote server 300 stores customer information corresponding to the serial number of the wireless remote monitoring apparatus 200 previously. When an image, location information and time information are transmitted to the remote server 300, the remote server 300 immediately transmits them to a callback center 400 by wire or wireless. Here, it is preferable to transmit the image, location information and time information together with the customer information such that the callback center 400 can cooperate with the customer. The customer information can include the telephone, address and name of the customer and a person in charge in the callback center.

The wireless transmission between the remote server 300 and the callback center 400 can be carried out using a cellular phone network, a wireless communication network of PHS data communication, Internet communication network and so on. The callback center 400 can be a repair shop, an insurance company, a police station and other security service companies.

The remote server 300 can radio-transmit all of the location of the car, image and time information about the car or a required part of them to the owner of the car using the cellular phone number previously stored therein because the owner of the car requires to know the abnormal state of the car.

In the meantime, problems related with car repairs, such as shortage of oil, flat tire, radiator trouble, low of fuel and so on, can be generated when the monitoring unit is not turned on. Accordingly, the wireless remote monitoring apparatus 200 for car security according to the present invention includes a hot key 280.

When the driver pushes the hot key 280 without regard to whether the monitoring unit 100 is turned on or off, the communication unit 240 is operated such that location information detected by the GPS 250 and time information obtained by the clock 260 are radio-transmitted to the remote server 300. The remote server 300 transmits the situation corresponding to the location information and time information by wireless to an appropriate callback center such as a repair shop or insurance company. Here, it is possible to operate the photographing unit 220 to transmit image information together with the location information and time information.

As described above, the present invention immediately transmits image information and location information of the outside or inside of a car to the remote server when an abnormal state of the car is detected. Accordingly, a manager in charge of the remote server can take follow-up measures rapidly. Furthermore, the present invention can notify a callback center, such as a repair shop, insurance company, police station or other security service companies, of the abnormal state of the car such that the callback center solve the problem in the car.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A wireless remote monitoring apparatus for car security, comprising:
a monitoring unit for monitoring an abnormal state of a car, such as forcible opening of a door of the car or an external shock applied to the car;
a photographing unite attached to the car for photographing the inside or outside of the car when the monitoring unit detects the abnormal state of the car;
a memory for storing an image photographed by the photographing unit;
a GPS unit attached to the car for obtaining location information of the car;
a clock for checking the time when the image and location information are obtained; and
a communication unit for radio-transmitting the image stored in the memory, the location information obtained by the GPS and the time information obtained by the clock to a remote server.

2. The wireless remote monitoring apparatus as claimed in claim 1, wherein the memory stores the location information obtained by the GPS and the time information obtained by the clock, and the communication unit radio-transmits the location information and time information stored in the memory.

3. The wireless remote monitoring apparatus as claimed in claim 1, wherein the remote server transmits the image, location information and time information stored in the memory to a callback center through wired or wireless communication.

4. The wireless remote monitoring apparatus as claimed in claim 3, wherein the remote server transmits customer information, such as the telephone number, address and name of a customer and a person in charge in the callback center, to the callback sensor through wired or wireless communication.

5. The wireless remote monitoring apparatus as claimed in claim 3, wherein the callback center includes a car repair shop, an insurance company, a police station and a security service company.

6. The wireless remote monitoring apparatus as claimed in claim 1, wherein the remote server transmits the image, location information and time information to a wireless communication terminal of the owner of the car through wireless communication.

7. The wireless remote monitoring apparatus as claimed in claim 1, wherein the communication unit is operated when the monitoring unit detects the abnormal state of the car.

8. The wireless remote monitoring apparatus as claimed in claim 1, further comprising a hot key for operating the communication unit, the communication unit being operated by the hot key to radio-transmit the location information obtained by the GPS and the time information obtained by the clock to the remote server.

9. The wireless remote monitoring apparatus as claimed in claim 8, wherein the remote server transmits the location information and time information, which are transmitted from the communication unit by the operation of the hot key, to the callback through wired or wireless communication.
